(19) United States
(12) Patent Application Publication
(10) Pub. No.: US 2021/0269363 A1
(43) Pub. Date: Sep. 2, 2021

(54) HIGH Q LTCC DIELECTRIC COMPOSITIONS AND DEVICES

(71) Applicant: Ferro Corporation, Mayfield Heigts, OH (US)

(72) Inventors: Peter Marley, Farmington, NY (US); Walter J. Symes, JR., Dundee, NY (US)

(21) Appl. No.: 17/259,281

(22) PCT Filed: Jul. 2, 2019
(86) PCT No.: PCT/US2019/040231

§ 371 Date: Jan. 11, 2021

Related U.S. Application Data
(60) Provisional application No. 62/696,416, filed on Jul. 11, 2018.

(51) Int. Cl. C04B 35/14; C04B 35/622; C04B 35/626

(52) U.S. Cl. CPC C04B 35/14; C04B 35/62222; C04B 35/626; C04B 2235/3284; C04B 2235/3206; C04B 2235/3418; C04B 2235/656; C04B 2235/442; C04B 2235/3409; C04B 2235/3281; C04B 2235/445; C04B 2235/5445; C04B 2235/5436; C04B 2235/3262

(57) ABSTRACT

LTCC devices are produced from dielectric compositions include a mixture of precursor materials that, upon firing, forms a dielectric material having a zinc-magnesium-manganese-silicon oxide host.

### BACKGROUND OF THE INVENTION

### 1. Field of Invention

This invention relates to dielectric compositions, and more particularly to Zinc-Magnesium-Manganese-Silicon oxide based dielectric compositions that exhibit a dielectric constant K=4-12 or alternately up to about 50, with very high Q factor at GHz high frequencies and that can be used in low temperature co-fired ceramic (LTCC) applications with noble metal metallization.

### 2. Description of Related Art

The state of the art materials used in LTCC systems for wireless applications use dielectrics with dielectric constant K=4-8 and with Q factors around 500-1,000 at the measuring frequency of 1 MHz. This is generally achieved by using a ceramic powder mixed with a high concentration of a BaO—CaO—B₂O₃ low softening temperature glass which allows the low temperature densification (875° C. or lower) of the ceramic. This large volume of glass can have the undesirable effect of lowering the Q value of said ceramic.

### SUMMARY OF THE INVENTION

This invention relates to dielectric compositions, and more particularly to a zinc-magnesium-manganese-silicate based dielectric compositions that exhibit a dielectric constant K=4-12 or alternately of up to 50, for example about 4 to about 50 with very high Q factor at GHz high frequencies and that can be used in low temperature co-fired ceramic (LTCC) applications with noble metal metallization. Q factor=1/Df, where Df is the dielectric loss tangent. The Qf value is a parameter used to describe the quality of a dielectric, typically at frequencies in the GHz range. Qf can be expressed as Qf=Q·f, where the measurement frequency f (in GHz) is multiplied by the Q factor at that frequency. There is growing demand for dielectric materials with very high Q values greater than 500 at >10 GHz for high frequency applications.

Broadly, the ceramic material of the invention includes a host which is made by mixing the appropriate amounts of ZnO, MgO, MnO, and SiO₂, milling these materials together in an aqueous medium to a particle size D₅₀ of about 0.2 to 5.0 microns. This slurry is dried and calcined at about 900 to 1250° C. for about 1 to 5 hours to form the host material including ZnO, MgO, MnO, and SiO₂. The resultant host material is then mechanically pulverized and mixed with fluxing agents and again milled in an aqueous medium to a particle size D₅₀ of about 0.5 to 1.0 μm. The milled ceramic powder is dried and pulverized to produce a finely divided powder. The resultant powder can be pressed into cylindrical pellets and fired at temperatures of about 775 to about 925° C., preferably about 800 to about 900° C., more preferably about 800 to about 880° C., more preferably about 825 to about 880° C., alternately about 845 to about 885° C., and even more preferably about 860 to about 880° C. or 870° C. to 880° C. The most preferable single values are 850° C. or 880° C. The firing is conducted for a time of about 1 to about 200 minutes, preferably about 5 to about 100 minutes, more preferably about 10 to about 50 minutes, still more preferably about 20 to about 40 minutes and most preferably for about 30 minutes.

An embodiment of the invention is a composition comprising a mixture of precursor materials that, upon firing, forms a zinc-magnesium-manganese-silicon oxide host material that is lead-free and cadmium-free and can, by itself, or in combination with other oxides, form a dielectric material.

In a preferred embodiment, the host material includes no lead. In an alternate preferred embodiment, the host material includes no cadmium. In a more preferred embodiment, the host material includes no lead and no cadmium.

In one embodiment, the host material comprises (i) 5-40 wt %, preferably 10-30 wt %, more preferably 15-25 wt % ZnO, (ii) 0-25 wt %, preferably 5-20 wt %, more preferably 0-10 wt % MgO, (iii) 50-95 wt %, preferably 60-95 wt %, more preferably 65-95 wt % and still more preferably 65-90 wt % and even more preferably 70-85 wt % SiO₂, and (iv) 0-5 wt %, preferably 0.1-3 wt %, more preferably 0.5-2.5 wt % MnO.

In another embodiment, the host material comprises (i) 5-40 wt %, preferably 10-30 wt %, more preferably 15-25 wt % MgO, (ii) 0-25 wt %, preferably 5-20 wt %, more preferably 0-10 wt % ZnO, (iii) 55-95 wt %, preferably 60-95 wt %, more preferably 65-95 wt % and still more preferably 70-90 wt % SiO₂, and (iv) 0-5 wt %, preferably 0.1-3 wt %, more preferably 0.5-2.5 wt % MnO.

In another embodiment, the host material comprises (i) 35-80 wt %, preferably 40-75 wt %, more preferably 45-70 wt % MgO (ii) 0-30 wt %, preferably 0-25 wt %, more preferably 5-20 wt % ZnO, (iii) 25-65 wt %, preferably 30-60 wt % SiO₂, and (iv) 0-5 wt %, preferably 0.1-3 wt %, more preferably 0.5-2.5 wt % MnO.

In another embodiment, the host material comprises (i) 10-35 wt %, preferably 10-25 wt % MgO, (ii) 0-10 wt %, preferably 0-5 wt % ZnO, (iii) 70-85 wt %, preferably 77-84 wt % SiO₂, and (iv) 0-5 wt %, preferably 0-3 wt % MnO.

An embodiment of the invention may include more than one host or a choice of hosts disclosed elsewhere herein.

A dielectric material of the invention may include 80-99 wt % of at least one host material disclosed herein together with any or all of the following in an amount not to exceed the indicated value in parentheses: SiO₂ (5 wt %); CaCO₃ (5 wt %); H₃BO₃ (8 wt %); Li₂CO₃ (5 wt %); LiF (5 wt %); CaF₂ (5 wt %) zinc borate (12 wt %) and also 0.1-5 wt % CuO. The dielectric materials of the invention contain no lead in any form and no cadmium in any form.

A dielectric material of the invention may include 20-50 wt % of at least one host material disclosed herein together with any or all of the following: 45-70 wt % SiO₂ 0.1-5 wt % CaCO₃; 0.1-8 wt % H₃BO₃; 0.1-5 wt % Li₂CO₃; 0.1-5 wt % CuO; 0-5 wt % LiF; 0-5 wt % CaF₂ and 0-5 wt % zinc borate.

A dielectric material of the invention may include 40-60 wt % of at least one host material disclosed herein together with any or all of the following: 30-50 wt % CaTiO₃; 0-5 wt % SiO₂; 0.1-5 wt % CaCO₃; 0.1-8 wt % H₃BO₃; 0.1-5 wt % Li₂CO₃; 0-5 wt % CuO; 0-5 wt % LiF; 0-5 wt % CaF₂ and 0-5 wt % zinc borate, no lead and no cadmium.

An embodiment of the invention is a lead-free and cadmium-free composition comprising a mixture of precursors that, upon firing, forms a lead-free and cadmium-free dielectric material comprising: (a) 0-40 wt % ZnO, (b) 0-30 wt % MgO, (c) 0-5 wt % MnO, (d) 55-90 wt % SiO₂, (e) 0-5 wt % CaO, (f) 0-5 wt % TiO₂, (g) 0.1-5 wt % B₂O₃, (h) 0.1-5 wt % Li₂O, (i) 0.1-5 wt % CuO, (j) 0-5 wt % CaF₂, (k) 0-5 wt % LiF, no lead and no cadmium.

An embodiment of the invention is a lead-free and cadmium-free composition comprising a mixture of precursors that, upon firing, forms a lead-free and cadmium-free dielectric material comprising: (a) 45-80 wt % ZnO, (b) 0-20 wt % MGO, (c) 0-5 wt % MnO, (d) 15-40 wt % SiO₂, (e) 0-5 wt % CaO, (f) 0-5 wt % TiO₂, (g) 0.1-8 wt % B₂O₃, (h) 0-5 wt % Li₂O, (i) 0.1-5 wt % CuO, (j) 0-5 wt % CaF₂, (k) 0-5 wt % LiF, no lead and no cadmium.

For any embodiment of the invention, a material range bounded by zero is considered to provide support for a similar range bounded by 0.01% or 0.1% at the lower end.

An embodiment of the invention is a lead-free and cadmium-free composition comprising a mixture of precursors that, upon firing, forms a lead-free and cadmium-free dielectric material comprising: (a) 0-25 wt % ZnO, (b) 40-70 wt % MgO, (c) 0-5 wt % MnO, (d) 15-55 wt % SiO₂, (f) 0-5 wt % CaO, (g) 0-5 wt % TiO₂, (h) 0.1-8 wt % B₂O₃, (i) 0-5 wt % Li₂O, (j) 0.1-5 wt % CuO, (k) 0-5 wt % CaF₂, (I) 0-5 wt % LiF, or equivalents of the foregoing, no lead and no cadmium.

In various embodiments of the invention a dielectric composition may include any host material disclosed elsewhere herein together with 0.3-4 wt % CaF₂, 0.5-4 wt % H₃BO₃, 0.1-4 wt % Li₂O₃, and 0.1-1 wt % CuO, or equivalents of the foregoing.

In one embodiment, a dielectric composition includes any host material disclosed elsewhere herein together with 1-30 wt % SiSiO₂, 0.3-4 wt % CaCO₃, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 55-75 wt % SiO₂, 0.3-4 wt % CaF₂, 0.5-4 wt % H₃BO₃, 0.1-4 wt % Li₂CO₃, and 0.1-1 wt % CuO, or equivalents of the foregoing.

In an additional embodiment, a dielectric composition includes any host material disclosed elsewhere herein together with 2-50 wt % CaTiO₃, 0.3-4 wt % CaCO₃, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 2-50 wt % CaTiO₃, 0.3-4 wt % CaF₂, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 0.3-4 wt % CaCO₃, 0.5-4 wt % H₃BO₃, 0.1-4 wt % Li₂CO₃, and 0.1-3 wt % CuO, or equivalents of the foregoing.

In another embodiment, a dielectric composition includes any host material disclosed elsewhere herein together with 0-6 wt % boric acid, 2-12 wt % zinc borate, 0.2-3 wt % LiF, and 0.1-3 wt % CuO, or equivalents of the foregoing.

In another embodiment, a dielectric composition includes any host material disclosed elsewhere herein together with 2-50 wt % CaTiO₃, 2-12 wt % zinc borate, 0.2-3 wt % LiF, and 0.1-3 wt % CuO, or equivalents of the foregoing.

In another embodiment, a dielectric composition includes any host material disclosed elsewhere herein together with 0.3-4 wt % CaCO₃, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 8-30 wt % SiO₂, 0.3-4 wt % CaF₂, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 55-75 wt % SiSiO₂, 0.3-4 wt % CaCO₃, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 2-50 wt % CaTiO₃, 0.3-4 wt % CaF₂, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 2-50 wt % CaTiO₃, 0.3-4 wt % CaCO₃, 0.5-4 wt % H₃BO₃, 0.1-4 wt % Li₂CO₃, and 0.1-1 wt % CuO, or equivalents of the foregoing.

In another embodiment, a dielectric composition includes any host material disclosed elsewhere herein together with 0.3-4 wt % CaF₂, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 8-30 wt % SiSiO₂, 0.3-4 wt % CaCO₃, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 55-75 wt % SiSiO₂, 0.3-4 wt % CaF₂, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 2-50 wt % CaTiO₃, 0.3-4 wt % CaCO₃, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 2-50 wt % CaTiO₃, 0.3-4 wt % CaF₂, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 0-4 wt % CaCO₃, 0.5-4 wt % H₃BO₃, 0-4 wt % LiF, and 0.1-1 wt % CuO, or equivalents of the foregoing.

In another embodiment, a dielectric composition includes any host material disclosed elsewhere herein together with 8-30 wt % SiO₂, 0.3-4 wt % CaF₂, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 55-75 wt % SiSiO₂, 0.3-4 wt % CaCO₃, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 2-50 wt % CaTiO₃, 0.3-4 wt % CaF₂, 0.5-4 wt % H₃BO₃, 0.1-4 wt % LiF, and 0.1-1 wt % CuO, or equivalents of the foregoing.

In another embodiment, a dielectric composition includes any host material disclosed elsewhere herein together with 2-50 wt % CaTiO₃, 0.3-4 wt % CaCO₃, 0.5-4 wt % H₃BO₃, 0.1-4 wt % LiF, and 0.1-1 wt % CuO, or equivalents of the foregoing.

For each compositional range bounded by zero weight percent, the range is considered to also teach a range with a lower bound of 0.01 wt % or 0.1 wt %. A teaching such as 60-90 wt % Ag+Pd+Pt+Au means that any or all of the named components can be present in the composition in the stated range.

In another embodiment, the invention relates to a lead-free and cadmium-free dielectric composition, comprising, prior to firing, any host material disclosed elsewhere herein.

In another embodiment, the present invention relates to an electric or electronic component comprising, prior to firing, any dielectric paste disclosed herein, together with a conductive paste comprising: (a) 60-90 wt % Ag+Pd+Pt+Au, (b) 1-10 wt % of an additive selected from the group consisting of silicides, carbides, nitrides, and borides of transition metals, (c) 0.5-10 wt % of at least one glass frit, and (d) 10-40 wt % of an organic portion. The electric or electronic component may be high Q resonators, band pass filters, wireless packaging systems, and combinations thereof.

In another embodiment, the present invention relates to a method of forming an electronic component comprising: applying any dielectric paste disclosed herein to a substrate; and firing the substrate at a temperature sufficient to sinter the dielectric material.

In another embodiment, the present invention relates to a method of forming an electronic component comprising applying particles of any dielectric material disclosed herein to a substrate and firing the substrate at a temperature sufficient to sinter the dielectric material.

In another embodiment, a method of the invention includes forming an electronic component comprising:
(a1) applying any dielectric composition disclosed herein to a substrate or
(a2) applying a tape comprising any dielectric composition disclosed herein to a substrate or
(a3) compacting a plurality of particles of any dielectric composition disclosed herein to form a monolithic composite substrate; and
(b) firing the substrate at a temperature sufficient to sinter the dielectric material.

A method according to the invention is a method of co-firing at least one layer of any dielectric material disclosed herein having a dielectric constant greater than 7 in combination with at least one alternating separate layer of tape or paste having a dielectric constant of less than 7 to form a multi-layer substrate wherein alternating layers have differing dielectric constants.

It is to be understood that each numerical value herein (percentage, temperature, etc.) is presumed to be preceded by “about.” In any embodiment herein the dielectric material may comprise different phases, for example crystalline and amorphous in any ratio, for example 1:99 to 99:1, (crystalline:amorphous) expressed in either mol% or wt %. Other ratios include 10:90, 20:80, 30:70, 40:60, 50:50, 60:40, 70:30, 80:20 and 90:10 as well as all values in between. In one embodiment the dielectric paste includes 10-30 wt % crystalline dielectric and 70-90 wt % amorphous dielectric.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

LTCC (Low Temperature Co-fired Ceramic), is a multi-layer, glass ceramic substrate technology which is co-fired with low resistance metal conductors, such as Ag, Au, Pt or Pd, or combinations thereof, at relatively low firing temperatures (less than 1000° C.). Sometimes it is referred to as “Glass Ceramics” because its main composition may consist of glass and alumina or other ceramic fillers. Some LTCC formulations are recrystallizing glasses. Glasses herein may be provided in the form of frits which may be formed in situ or added to a composition. In some situations, base metals such as nickel and its alloys may be used, ideally in non-oxidizing atmospheres, such as oxygen partial pressures of 10⁻¹² to 10⁻⁸ atmospheres. A “base metal” is any metal other than gold, silver, palladium, and platinum. Alloying metals may include Mn, Cr, Co, and Al.

A tape cast from a slurry of dielectric material is cut, and holes known as vias are formed to enable electrical connection between layers. The vias are filled with a conductive paste. Circuit patterns are then printed, along with co-fired resistors as needed. Multiple layers of printed substrates are stacked. Heat and pressure are applied to the stack to bond layers together. Low temperature (<1000° C.) sintering is then undertaken. The sintered stacks are sawn to final dimensions and post fire processing completed as needed.

Multilayer structures useful in automotive applications may have about 5 ceramic layers, for example 3-7 or 4-6. In RF applications, a structure may have 10-25 ceramic layers. As a wiring substrate, 5-8 ceramic layers may be used.

Dielectric Pastes. A paste for forming the dielectric layers can be obtained by mixing an organic vehicle with a raw dielectric material, as disclosed herein. Also useful are precursor compounds (carbonates, nitrates, sulfates, phosphates) that convert to such oxides and composite oxides upon firing, as stated hereinabove. The dielectric material is obtained by selecting compounds containing these oxides, or precursors of these oxides, and mixing them in the appropriate proportions. The proportion of such compounds in the raw dielectric material is determined such that after firing, the desired dielectric layer composition may be obtained. The raw dielectric material (as disclosed elsewhere herein) is generally used in powder form having a mean particle size of about 0.1 to about 3 microns, and more preferably about 1 micron or less.

Organic Vehicle. The pastes herein include an organics portion. The organics portion is or includes an organic vehicle, which is a binder in an organic solvent or a binder in water. The choice of binder used herein is not critical; conventional binders such as ethyl cellulose, polyvinyl butanol, ethyl cellulose, and hydroxypropyl cellulose, and combinations thereof are appropriate together with a solvent. The organic solvent is also not critical and may be selected in accordance with a particular application method (i.e., printing or sheeting), from conventional organic solvents such as butyl carbitol, acetone, toluene, ethanol, diethylene glycol butyl ether; 2,2,4-trimethyl pentanediol monoisobutyrate (Texanol®; alpha-terpineol; beta-terpineol; gamma terpineol; tridecyl alcohol; diethylene glycol ethyl ether (Carbitol®), diethylene glycol butyl ether (Butyl Carbitol®) and propylene glycol; and blends thereof, Products sold under the Texanol® trademark are available from Eastman Chemical Company, Kingsport, Tenn.; those sold under the Dowanol® and Carbitol® trademarks are available from Dow Chemical Co., Midland, Mich.

No particular limit is imposed on the organics portion of the dielectric pastes of the invention. In one embodiment the dielectric pastes of the invention include from about 10 wt % to about 40 wt % of the organic vehicle; in another, from about 10 wt % to about 30 wt %. Often the paste contains about 1 to 5 wt % of the binder and about 10 to 50 wt % of the organic solvent, with the balance being the dielectric component (solids portion). In one embodiment, the dielectric paste of the invention includes from about 60 to about 90 wt % of solids portion elsewhere disclosed, and from about 10 wt % to about 40 wt % of the organics portion described in this and the preceding paragraph. If desired, the pastes of the invention may contain up to about 10 wt % of other additives such as dispersants, plasticizers, dielectric compounds, and insulating compounds.

Filler. In order to minimize expansion mismatch between tape layers of differing dielectric compositions, fillers such as cordierite, alumina, zircon, fused silica, aluminosilicates and combinations thereof may be added to one or more dielectric pastes herein in an amount of 1-30 wt %, preferably 2-20 wt % and more preferably 2-15 wt %.

Firing. The dielectric stack (two or more layers) is then fired in an atmosphere, which is determined according to the type of conductor in the internal electrode layer-forming paste. Where the internal electrode layers are formed of a base metal conductor such as nickel and nickel alloys, the firing atmosphere may have an oxygen partial pressure of about 10⁻¹² to about 10⁻⁸ atm. Sintering at a partial pressure lower than about 10⁻¹² atm should be avoided, since at such low pressures the conductor can be abnormally sintered and may become disconnected from the dielectric layers. At oxygen partial pressures above about 10⁻⁸ atm, the internal electrode layers may be oxidized. Oxygen partial pressures of about 10⁻¹¹ to about 10⁻⁹ atm are most. It is also possible to fire the dielectric compositions disclosed herein in ambient air. However, reducing atmospheres (H₂, N₂ or H₂/N₂) can undesirably reduce Bi₂O₃ from a dielectric paste to metallic bismuth.

Applications for the LTCC compositions and devices disclosed herein include band pass filters, (high pass or low pass), wireless transmitters and receivers for telecommunications including cellular applications, power amplifier modules (PAM), RF front end modules (FEM), WiMAX2 modules, LTE-advanced modules, transmission control units (TCU), electronic power steering (EPS), engine management systems (EMS), various sensor modules, radar modules, pressure sensors, camera modules, small outline tuner modules, thin profile modules for devices and components, and IC tester boards. Band-pass filters contain two major parts, one a capacitor and the other an inductor. Low K material is good for designing the inductor, but not suitable for designing a capacitor due the requirement for more active area to generate sufficient capacitance. High K material will result in the opposite. The inventors have discovered that Low K (4-8)/Mid K (10-100) LTCC material can be co-fired and put into a single component, low K materials can be used to design inductor area and high K material can be used to design capacitor area to have optimized performance.

### EXAMPLES

The following examples are provided to illustrate preferred aspects of the invention and are not intended to limit the scope of the invention.

As seen in the tables below, appropriate amounts of Mg(OH)₂, ZnO, MnO, and SiO₂, are mixed and then milled together in an aqueous medium to a particle size D₅₀ of about 0.2 to 1.5 μm. This slurry is dried and calcined at about 800 to 1250° C. for about 1 to 10 hours to form the host material including MgO, ZnO, MnO, and SiO₂. The resultant host material is then mechanically pulverized and mixed with fluxing agents and dopants and again milled in an aqueous medium to a particle size D₅₀of about 0.5 to 1.0 μm. The milled ceramic powder is dried and pulverized to produce a finely divided powder. The resultant powder is pressed into cylindrical pellets and fired at a temperature of about 880° C. for about 30 minutes. Formulations are given in weight percent.

TABLE 1
Host compositions in weight %.

| Host | A | B | C | D | E | F |
|---|---|---|---|---|---|---|
| ZnO | 21.790 | 0.000 | 73.038 | 0.000 | 60.927 | 8.125 |
| MgO | 0.000 | 19.734 | 0.000 | 57.295 | 9.500 | 54.460 |
| MnO | 0.234 | 0.000 | 0.000 | 0.000 | 0.000 | 0.000 |
| SiO₂ | 77.976 | 80.266 | 26.962 | 42.705 | 29.573 | 37.415 |

TABLE 2
Dielectric Formulations in weight %.

| Formulation | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Host A | 93.577 | 93.619 | 0.000 | 0.000 | 0.000 | 0.000 | 0.000 | 0.000 | 0.000 | 0.000 | 0.000 | 0.000 | 0.000 | 0.000 |
| Host B | 0.000 | 0.000 | 93.574 | 0.000 | 0.000 | 0.000 | 0.000 | 0.000 | 0.000 | 0.000 | 0.000 | 0.000 | 0.000 | 0.000 |
| Host C | 0.000 | 0.000 | 0.000 | 95.614 | 88.186 | 51.590 | 45.652 | 0.000 | 0.000 | 0.000 | 76.510 | 6.708 | 0.000 | 0.000 |
| Host D | 0.000 | 0.000 | 0.000 | 0.000 | 0.000 | 0.000 | 0.000 | 26.622 | 88.259 | 94.162 | 19.104 | 86.407 | 0.000 | 0.000 |
| Host E | 0.000 | 0.000 | 0.000 | 0.000 | 0.000 | 0.000 | 0.000 | 0.000 | 0.000 | 0.000 | 0.000 | 0.000 | 95.614 | 0.000 |
| Host F | 0.000 | 0.000 | 0.000 | 0.000 | 0.000 | 0.000 | 0.000 | 0.000 | 0.000 | 0.000 | 0.000 | 0.000 | 0.000 | 94.162 |
| SiO₂ | 0.000 | 0.000 | 0.000 | 0.180 | 0.000 | 0.000 | 51.089 | 66.743 | 0.000 | 0.000 | 0.180 | 0.000 | 0.180 | 0.000 |
| CaCO₃ | 0.488 | 0.000 | 0.491 | 2.055 | 0.000 | 0.492 | 0.488 | 0.491 | 0.000 | 0.475 | 2.055 | 0.000 | 2.055 | 0.475 |
| H₃BO₃ | 2.997 | 2.999 | 2.997 | 1.276 | 0.000 | 3.011 | 1.184 | 2.997 | 5.371 | 2.305 | 1.276 | 0.000 | 1.276 | 2.305 |
| Li₂CO₃ | 2.555 | 2.556 | 2.555 | 0.257 | 0.000 | 2.569 | 1.009 | 2.764 | 0.000 | 1.965 | 0.257 | 0.000 | 0.257 | 1.965 |
| CuO | 0.383 | 0.334 | 0.383 | 0.363 | 1.110 | 0.000 | 0.578 | 0.383 | 0.595 | 1.093 | 0.363 | 0.628 | 0.363 | 1.093 |
| LiF | 0.000 | 0.000 | 0.000 | 0.000 | 1.296 | 0.000 | 0.000 | 0.000 | 1.297 | 0.000 | 0.000 | 1.368 | 0.000 | 0.000 |
| CaF₂ | 0.000 | 0.492 | 0.000 | 0.255 | 0.000 | 0.000 | 0.000 | 0.000 | 0.000 | 0.000 | 0.255 | 0.000 | 0.255 | 0.000 |
| Zinc Borate | 0.000 | 0.000 | 0.000 | 0.000 | 9.408 | 0.000 | 0.000 | 0.000 | 4.478 | 0.000 | 0.000 | 4.889 | 0.000 | 0.000 |
| CaTiO₃ | 0.000 | 0.000 | 0.000 | 0.000 | 0.000 | 42.338 | 0.000 | 0.000 | 0.000 | 0.000 | 0.000 | 0.000 | 0.000 | 0.000 |

The following table presents properties and performance data of the formulations set forth Table 2.

TABLE 3
K & Qf data for formulations 1-14 after sintering at 880° C.
for 30 minutes:

| Formulation | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Frequency | 16.90 | 14.52 | 17.00 | 14.51 | 13.58 | 8.12 | 15.96 | 16.85 | 13.10 | 15.95 | 14.65 | 13.72 | 14.25 | 13.72 |
| (GHz) | | | | | | | | | | | | | | |
| K | 4.92 | 5.15 | 4.90 | 6.21 | 6.86 | 43.90 | 5.28 | 5.10 | 6.67 | 6.35 | 6.20 | 6.89 | 6.02 | 7.00 |
| Qf | 6,706 | 7,550 | 6,044 | 16,252 | 12,926 | 6,430 | 8,597 | 6,851 | 16,362 | 16,391 | 16,814 | 17,482 | 15,906 | 17,624 |

TABLE 4
includes compositions in weight % for formulations 1-14 after sintering
at 880° C. for 30 minutes:

| Formulation | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| ZnO | 21.031 | 20.994 | 0.000 | 71.111 | 72.118 | 38.871 | 33.794 | 0.000 | 3.620 | 0.000 | 56.798 | 8.770 | 59.211 | 7.838 |
| MgO | 0.000 | 0.000 | 19.046 | 0.000 | 0.000 | 0.000 | 0.000 | 15.753 | 51.887 | 55.269 | 11.125 | 49.613 | 9.232 | 52.534 |
| MnO | 0.226 | 0.225 | 0.000 | 0.000 | 0.000 | 0.000 | 0.000 | 0.000 | 0.000 | 0.000 | 0.000 | 0.000 | 0.000 | 0.000 |
| SiO₂ | 75.260 | 75.129 | 77.469 | 26.250 | 23.875 | 14.349 | 64.254 | 80.671 | 39.449 | 41.195 | 29.442 | 38.719 | 28.923 | 36.092 |
| CaO | 0.282 | 0.000 | 0.284 | 1.172 | 0.000 | 18.300 | 0.277 | 0.284 | 0.000 | 0.273 | 1.170 | 0.000 | 1.170 | 0.273 |
| TiO₂ | 0.000 | 0.000 | 0.000 | 0.000 | 0.000 | 25.659 | 0.000 | 0.000 | 0.000 | 0.000 | 0.000 | 0.000 | 0.000 | 0.000 |
| B₂O₃ | 1.740 | 1.738 | 1.740 | 0.731 | 1.592 | 1.749 | 0.676 | 1.743 | 3.103 | 1.329 | 0.730 | 0.826 | 0.730 | 1.329 |
| Li₂O | 1.066 | 1.064 | 1.066 | 0.106 | 0.000 | 1.072 | 0.414 | 1.154 | 0.000 | 0.814 | 0.106 | 0.000 | 0.106 | 0.814 |
| CuO | 0.395 | 0.344 | 0.395 | 0.370 | 1.115 | 0.000 | 0.586 | 0.396 | 0.611 | 1.120 | 0.369 | 0.629 | 0.369 | 1.120 |
| CaF₂ | 0.000 | 0.506 | 0.000 | 0.260 | 0.000 | 0.000 | 0.000 | 0.000 | 0.000 | 0.000 | 0.000 | 0.000 | 0.259 | 0.000 |
| LiF | 0.000 | 0.000 | 0.000 | 0.000 | 1.301 | 0.000 | 0.000 | 0.000 | 1.331 | 0.000 | 0.259 | 1.371 | 0.000 | 0.000 |

The invention is further defined by the following items.

Item 1: A lead-free and cadmium-free dielectric material comprising, prior to firing:
(a) 80-99 wt % of at least one host material selected from the group consisting of
   Host I, Host II, Host III and Host IV, wherein:
      1. Host I comprises:
         i) 10-30 wt % ZnO,
         ii) 0-10 wt % MgO,
         iii) 65-90 wt % SiO₂, and
         iv) 0-5 wt % MnO;
      2. Host II comprises:
         i) 10-30 wt % MgO,
         ii) 0-10 wt % ZnO,
         iii) 70-90 wt % SiO₂, and
         iv) 0-5 wt % MnO;
      3. Host III comprises:
         i) 50-85 wt % ZnO,
         ii) 0-20 wt % MgO,
         iii) 15-40 wt % SiO₂, and
         iv) 0-5 wt % MnO; and
      4. Host IV comprises:
         i) 45-70 wt % MgO,
         ii) 0-25 wt % ZnO,
         iii) 30-55 wt % SiO₂, and
         iv) 0-5 wt % MnO;
together with
(b) 0-5 wt % SiO₂,
(c) 0-5 wt % CaCO₃,
(d) 0-8 wt % H₃BO₃,
(e) 0-5 wt % Li₂CO₃,
(f) 0.1-5 wt % CuO,
(g) 0-5 wt % LiF,
(h) 0-5 wt % CaF₂, and
(i) 0-12 wt % zinc borate,
   or oxide equivalents of any of the foregoing, no lead and no cadmium.

Item 2: A lead-free and cadmium-free dielectric material comprising, prior to firing
(a) 20-50 wt % of at least one host material selected from the group consisting of
   Host I, Host II, Host III and Host IV, wherein:
      1. Host I comprises:
         i) 10-30 wt % ZnO,
         ii) 0-10 wt % MgO,
         iii) 65-90 wt % SiO₂, and
         iV) 0-5 wt % MnO,
      2. Host II comprises:
         i) 10-30 wt % MgO,
         ii) 0-10 wt % ZnO,
         iii) 70-90 wt % SiO₂, and
         iv) 0-5 wt % MnO;
      3. Host III comprises:
         i) 50-85 wt % ZnO,
         ii) 0-20 wt % MgO,
         iii) 15-40 wt % SiO₂, and
         iv) 0-5 wt % MnO; and
      4. Host IV comprises:
         i) 45-70 wt % MgO,
         ii) 0-25 wt % ZnO,
         iii) 30-55 wt % SiO₂, and
         iv) 0-5 wt % MnO;
            together with
(b) 45-70 wt % SiO₂,
(c) 0.1-5 wt % CaCO₃,
(d) 0.1-8 wt % H₃BO₃,
(e) 0.1-5 wt % Li₂CO₃,
(f) 0.1-5 wt % CuO,
(g) 0-5 wt % LiF,
(h) 0-5 wt % CaF₂, and
(i) 0-5 wt % zinc borate,
   or oxide equivalents of any of the foregoing, no lead and no cadmium.

Item 3: A lead-free and cadmium-free dielectric material comprising, prior to firing:
(a) 40-60 wt % of at least one host material selected from the group consisting of
   Host I, Host II, Host III and Host IV, wherein:
      1. Host I comprises:
         i) 10-30 wt % ZnO,
         ii) 0-10 wt % MgO,
         iii) 65-90 wt % SiO₂, and
         iv) 0-5 wt % MnO;
      2. Host II comprises:
         i) 10-30 wt % MGO,
         ii) 0-10 wt % ZnO,
         iii) 70-90 wt % SiO₂, and
         iv) 0-5 wt % MnO;
      3. Host III comprises:
         i) 50-85 wt % ZnO,
         ii) 0-20 wt % MGO,
         iii) 15-40 wt % SiO₂, and
         iv) 0-5 wt % MnO; and
      4. Host IV comprises:
         i) 45-70 wt % MGO,
         ii) 0-25 wt % ZnO,
         iii) 30-55 wt % SiO₂, and
         iv) 0-5 wt % MnO;
together with
(b) 30-50 wt % CaTiO₃,
(c) 0-5 wt % SiO₂,
(d) 0.1-5 wt % CaCO₃,
(e) 0.1-8 wt % H₃BO₃,
(f) 0.1-5 wt % Li₂CO₃,
(g) 0-5 wt % CuO,
(h) 0-5 wt % LiF,
(i) 0-5 wt % CaF₂, and
(j) 0-5 wt % zinc borate,
   or oxide equivalents of any of the foregoing, no lead and no cadmium.

Item 4: The dielectric material of any of items 1-3, wherein the dielectric material is in powder form.

Item 5: A lead-free and cadmium-free composition comprising a mixture of precursors that, upon firing, forms a lead-free and cadmium-free dielectric material comprising:
(a) 0-40 wt % ZnO,
(b) 0-30 wt % MgO,
(c) 0-5 wt % MnO,
(d) 55-90 wt % SiO₂,
(e) 0-5 wt % CaO,
(f) 0-5 wt % TiO₂,
(g) 0.1-5 wt % B₂O₃,
(h) 0.1-5 wt % Li₂O,
(i) 0.1-5 wt % CuO,
(j) 0-5 wt % CaF₂, and
(k) 0-5 wt % LiF,
   no lead and no cadmium.

Item 6: A lead-free and cadmium-free composition comprising a mixture of precursors that, upon firing, forms a lead-free and cadmium-free dielectric material comprising:
(a) 30-50 wt % ZnO,
(b) 0-10 wt % MgO,
(c) 0-5 wt % MnO,
(d) 5-25 wt % SiO₂,
(e) 8-28 wt % CaO,
(f) 15-35 wt % TiO₂,
(g) 0.1-5 wt % B₂O₃,
(h) 0.1-5 wt % Li₂O,
(i) 0-5 wt % CuO,
(j) 0-5 wt % CaF₂,
(k) 0-5 wt % LiF,
   no lead and no cadmium.

Item 7: A lead-free and cadmium-free composition comprising a mixture of precursors that, upon firing, forms a lead-free and cadmium-free dielectric material comprising:
(a) 45-80 wt % ZnO,
(b) 0-20 wt % MgO,
(c) 0-5 wt % MnO,
(d) 15-40 wt % SiO₂,
(e) 0-5 wt % CaO,
(f) 0-5 wt % TiO₂,
(g) 0.1-8 wt % B₂O₃,
(h) 0-5 wt % Li₂O,
(i) 0.1-5 wt % CuO,
(j) 0-5 wt % CaF₂,
(k) 0-5 wt % LiF,
   no lead and no cadmium.

Item 8: A lead-free and cadmium-free composition comprising a mixture of precursors that, upon firing, forms a lead-free and cadmium-free dielectric material comprising:
(a) 0-25 wt % ZnO,
(b) 40-70 wt % MgO,
(c) 0-5 wt % MnO,
(d) 15-55 wt % SiO₂,
(e) 0-5 wt % CaO,
(f) 0-5 wt % TiO₂,
(g) 0.1-8 wt % B₂O₃,
(h) 0-5 wt % Li₂O,
(i) 0.1-5 wt % CuO,
(j) 0-5 wt % CaF₂,
(k) 0-5 wt % LiF,
   no lead and no cadmium.

Item 9: The lead-free and cadmium-free dielectric material of any of items 1-4 or dielectric composition of any of items 5-8, wherein, after firing, the material or composition exhibits a Qf value of at least 5000 when measured at greater than 1 GHz.

Item 10: The lead-free and cadmium-free dielectric material of any of items 1-4 or dielectric composition of any of items 5-8, wherein, after firing, the material or composition exhibits a dielectric constant K of 3-50.

Item 11: An electric or electronic component comprising, prior to firing, the lead-free and cadmium-free dielectric material of any of items 1-4 or dielectric composition of any of items 5-8, together with a conductive paste comprising:
a. 60-90 wt % Ag+Pd+Pt+Au,
b. 1-10 wt % of an additive selected from the group consisting of silicides, carbides, nitrides, and borides of transition metals,
c. 0.5-10 wt % of at least one glass frit, and
d. 10-40 wt % of an organic portion.

Item 12: The electric or electronic component of item 10, wherein the electric or electronic component is selected from the group consisting of high Q resonators, electro-magnetic interference filters, band pass filters, wireless packaging systems, and combinations thereof.

Item 13: A method of forming an electronic component comprising:
(a1) applying the dielectric material of any of items 1-4 or dielectric composition of any of items 5-8 to a substrate; or
(a2) applying a tape comprising the dielectric material of any of items 1-4 or dielectric composition of any of items 5-8 to a substrate; or
(a3) compacting a plurality of particles of the dielectric material of any of items 1-4 or dielectric composition of any of items 5-8 to form a monolithic composite substrate; and
(b) firing the substrate at a temperature sufficient to sinter the dielectric material.

Item 14: The method of item 13, wherein the firing is conducted at a temperature of from about 800° C. to about 900° C.

Item 15: A method of co-firing at least one layer of the dielectric material of any of items 1-4 or dielectric composition of any of items 5-8 having a dielectric constant less than 7 in combination with at least one alternating separate layer of tape or paste having a dielectric constant of greater than 7 to form a multi-layer substrate wherein alternating layers have differing dielectric constants.

Item 16: The method of item 15, wherein the firing is conducted at a temperature of from about 800° C. to about 900° C.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1-16. (cancel)

17. A host material selected from the group consisting of Host I, Host II, Host III and Host IV, wherein:
1. Host I comprises:
i) 10-30 wt % ZnO,
ii) 0-10 wt % MgO,
iii) 65-90 wt % SiO₂, and
iv) 0-5 wt % MnO;
2. Host II comprises:
i) 10-30 wt % MgO,
ii) 0-10 wt % ZnO,
iii) 70-90 wt % SiO₂, and
iv) 0-5 wt % MnO;

3. Host III comprises:
i) 50-85 wt % ZnO,
ii) 0-20 wt % MgO,
iii) 15-40 wt % SiO₂, and
iv) 0-5 wt % MnO; and

4. Host IV comprises:
i) 45-70 wt % MgO,
ii) 0-25 wt % ZnO,
iii) 30-55 wt % SiO₂, and
iv) 0-5 wt % MnO.

18. A lead-free and cadmium-free dielectric material comprising, prior to firing:
(a) 80-99 wt % of at least one host material of claim 17 together with
(b) 0-5 wt % SiO₂,
(c) 0-5 wt % CaCO₃,
(d) 0-8 wt % H₃BO₃,
(e) 0-5 wt % Li₂CO₃,
(f) 0.1-5 wt % CuO,
(g) 0-5 wt % LiF,
(h) 0-5 wt % CaF₂, and
(i) 0-12 wt % zinc borate,
or oxide equivalents of any of the foregoing, no lead and no cadmium.

19. A lead-free and cadmium-free dielectric material comprising, prior to firing:
(a) 20-50 wt % of at least one host material of claim 17 together with
(b) 45-70 wt % SiO₂,
(c) 0.1-5 wt % CaCO₃,
(d) 0.1-8 wt % H₃BO₃,
(e) 0.1-5 wt % Li₂CO₃,
(f) 0.1-5 wt % CuO,
(g) 0-5 wt % LiF,
(h) 0-5 wt % CaF₂, and
(i) 0-5 wt % zinc borate,
or oxide equivalents of any of the foregoing, no lead and no cadmium.

20. A lead-free and cadmium-free dielectric material comprising, prior to firing:
(a) 40-60 wt % of at least one host material of claim 17 together with
(b) 30-50 wt % CaTiO₃,
(c) 0-5 wt % SiO₂,
(d) 0.1-5 wt % CaCO₃,
(e) 0.1-8 wt % H₃BO₃
(f) 0.1-5 wt % Li₂CO₃,
(g) 0-5 wt % CuO,
(h) 0-5 wt % LiF,
(i) 0-5 wt % CaF₂, and
(j) 0-5 wt % zinc borate,
or oxide equivalents of any of the foregoing, no lead and no cadmium.

21. The dielectric material of claim 18, wherein the dielectric material is in powder form.

22. The dielectric material of claim 18, wherein a mean particle size ranges 0.1-3 microns.

23. The dielectric material of claim 18, wherein the dielectric material comprises a crystalline phase and an amorphous phase.

24. The dielectric material of claim 18, upon firing, comprising a low temperature cofired ceramic (LTCC).

25. A lead-free and cadmium-free composition comprising a mixture of precursors that, upon firing, forms a lead-free and cadmium-free dielectric material comprising:
(a) 0-40 wt % ZnO,
(b) 0-30 wt % MgO,
(c) 0-5 wt % MnO,
(d) 55-90 wt % SiO₂,
(e) 0-5 wt % CaO,
(f) 0-5 wt % TiO₂,
(g) 0.1-5 wt % B₂O₃,
(h) 0.1-5 wt % Li₂O,
(i) 0.1-5 wt % CuO,
(j) 0-5 wt % CaF₂, and
(k) 0-5 wt % LiF,
no lead and no cadmium.

26. A lead-free and cadmium-free composition comprising a mixture of precursors that, upon firing, forms a lead-free and cadmium-free dielectric material comprising:
(a) 30-50 wt % ZnO,
(b) 0-10 wt % MgO,
(c) 0-5 wt % MnO,
(d) 5-25 wt % SiO₂,
(e) 8-28 wt % CaO,
(f) 15-35 wt % TiO₂,
(g) 0.1-5 wt % B₂O₃,
(h) 0.1-5 wt % Li₂O,
(i) 0-5 wt % CuO,
(j) 0-5 wt % CaF₂,
(k) 0-5 wt % LiF,
no lead and no cadmium.

27. A lead-free and cadmium-free composition comprising a mixture of precursors that, upon firing, forms a lead-free and cadmium-free dielectric material comprising:
(a) 45-80 wt % ZnO,
(b) 0-20 wt % MgO,
(c) 0-5 wt % MnO,
(d) 15-40 wt % SiO₂,
(e) 0-5 wt % CaO,
(f) 0-5 wt % TiO₂,
(g) 0.1-8 wt % B₂O₃,
(h) 0-5 wt % Li₂O,
(i) 0.1-5 wt % CuO,
(j) 0-5 wt % CaF₂,
(k) 0-5 wt % LiF,
no lead and no cadmium.

28. A lead-free and cadmium-free composition comprising a mixture of precursors that, upon firing, forms a lead-free and cadmium-free dielectric material comprising:
(a) 0-25 wt % ZnO,
(b) 40-70 wt % MgO,
(c) 0-5 wt % MnO,
(d) 15-55 wt % SiO₂,
(e) 0-5 wt % CaO,
(f) 0-5 wt % TiO₂,
(g) 0.1-8 wt % B₂O₃,
(h) 0-5 wt % Li₂O,
(i) 0.1-5 wt % CuO,
(j) 0-5 wt % CaF₂,
(k) 0-5 wt % LiF,
no lead and no cadmium.

29. The lead-free and cadmium-free dielectric material of claim 25, wherein, after firing, the material or composition exhibits a Qf value of at least 5000 when measured at greater than 1 GHz.

30. The lead-free and cadmium-free dielectric material of claim 25, wherein, after firing, the material or composition exhibits a dielectric constant K of 3-50.

31. The lead-free and cadmium-free dielectric material of claim 25, wherein the dielectric material comprises a low temperature cofired ceramic (LTCC).

32. An electric or electronic component comprising, prior to firing, the lead-free and cadmium-free dielectric material of claim 18, together with a conductive paste comprising:
(a) 60-90 wt % Ag+Pd+Pt+Au,
(b) 1-10 wt % of an additive selected from the group consisting of silicides, carbides, nitrides, and borides of transition metals,
(c) 0.5-10 wt % of at least one glass frit, and
(d) 10-40 wt % of an organic portion.

33. The electric or electronic component of claim 32, wherein the electric or electronic component is selected from the group consisting of high Q resonators, electro-magnetic interference filters, band pass filters, wireless packaging systems, and combinations thereof.

34. A method of forming an electronic component comprising:
(a1) applying the dielectric material of claim 18 to a substrate; or
(a2) applying a tape comprising the dielectric material of claim 18 to a substrate; or
(a3) compacting a plurality of particles of the dielectric material of claim 18 to form a monolithic composite substrate; and
(b) firing the substrate at a temperature sufficient to sinter the dielectric material.

35. The method of claim 34, wherein the firing is conducted at a temperature of from about 800° C. to about 900° C.

36. A multilayer structure comprising at least one layer of the dielectric material of claim 25 having a dielectric constant less than 7 in combination with at least one alternating separate layer of tape or paste having a dielectric constant of greater than 7 to form a multi-layer substrate wherein alternating layers have differing dielectric constants.

37. A method of co-firing the multilayer structure of claim 34, wherein the co-firing is conducted at a temperature of from about 800° C. to about 900° C.

38. A paste comprising the dielectric material of claim 18, wherein the paste comprises 10-30 wt % crystalline dielectric and 70-90 wt % amorphous dielectric.
